(19) United States
(12) Patent Application Publication
(10) Pub. No.: US 2013/0219387 A1
(43) Pub. Date: Aug. 22, 2013

(54) ESTABLISHING SECURE TWO-WAY COMMUNICATIONS IN A VIRTUALIZATION PLATFORM

(71) Applicants: Jan MOELLER, Galten (DK); Steffen GRARUP, Hoejbjerg (DK); Rene W. SCHMIDT, Risskov (DK)

(72) Inventors: Jan MOELLER, Galten (DK); Steffen GRARUP, Hoejbjerg (DK); Rene W. SCHMIDT, Risskov (DK)

(73) Assignee: VMWARE, INC., Palo Alto, CA (US)

(21) Appl. No.: 13/402,517

(22) Filed: Feb. 22, 2012

(51) Int. Cl. G06F 9/455

(52) U.S. Cl. 718/1

(57) ABSTRACT

In a specific embodiment, a secure two-way multi-message communication channel between a virtualization platform and a guest running on a virtual machine hosted on the virtualization platform is provided using the OVF environment channel. The OVF environment may be used to transmit communication parameters from the platform to the virtual machine during power-on. At runtime, a guest executing on the virtual machine may use the communication parameters to establish a secure two-way communication channel with the virtualization platform.

### BACKGROUND

The computing environment of an enterprise typically involves a large collection of interoperating computing systems. Virtualization provides a platform to manage multiple computing systems in the form of virtual machines. To facilitate the deployment of virtual machines on a virtualization platform, methods have been developed to describe virtual machines. An industry standard has been developed, known as the Open Virtualization Format (OVF). The OVF specification, entitled “Open Virtualization Format Specification,” Document Number DSP0234, Version 1.1.0 (Jan. 1, 2010), published by Distributed Management Task Force, Inc. (DMTF), describes the packaging and distribution of software to be run in virtual machines, and is incorporated herein by reference in its entirety for all purposes. The OVF format is described in a white paper entitled “Open Virtualization Format White Paper,” Document Number DSP2107, Version 1.0.0 (Feb. 6, 2009), published by DMTF, and is incorporated herein by reference in its entirety for all purposes.

A virtual machine typically needs to be customized to function properly in the particular virtualization platform on which it is deployed. For example, the OVF standard describes a run-time format called the OVF environment for communicating information into virtual machines. The OVF environment is generated when the virtual machine is powered on and can be transported to the guest using an ISO image in the first CD-ROM drive of the virtual machine, for example. The transport is considered secure because only the virtualization platform can write the OVF environment and only the guest reads the OVF environment.

The OVF environment therefore constitutes a secure one-time and one-way communication of information from the virtualization platform to the guest. However, it is often desirable to establish a secure two-way multi-messaging communication channel between the virtualization platform and the guest. Network communication is a standardized and natural choice when a virtual machine needs to communicate with external systems including the virtualization platform, but network communication is potentially insecure and there are many protocols to choose from.

### SUMMARY

In some embodiments, a method in a virtualization platform for starting a virtual machine includes reading in environment information relating to the virtual machine and producing communication parameters that allow the virtual machine to communicate with the virtualization platform. Both the environment information and the communication parameters are provided to the virtual machine as part of its boot up sequence. The method includes the virtualization platform receiving a communication from a guest on the virtual machine using information contained in the communication parameters provided to the virtual machine.

In embodiments, the virtual machine receives the communication over a communication network. The virtualization platform may authenticate the received communication and may then send a communication to the guest, thus establishing a two-way communications channel.

In embodiments, the communication may be conducted over an HTTPS connection, thus providing secure messaging over the two-way communication channel.

The following detailed description and accompanying drawings provide a more detailed understanding of the nature and advantages of the present disclosure.

### BRIEF DESCRIPTION OF THE DRAWINGS

FIG. 1 illustrates a virtualization platform in accordance with the present disclosure.

FIG. 1A shows an example of a process executing on a virtualization platform having a guest API.

FIG. 2 illustrates a specific embodiment of a virtualization platform of the present disclosure.

FIG. 3 shows the basic workflow for deploying a virtual machine.

FIG. 4 shows the basic workflow for starting up a virtual machine.

FIG. 5 is a specific example of environment information.

FIG. 6 is a specific example of environment information combined with communication parameters.

FIGS. 7A and 7B illustrate an example of a communication channel between virtual machines.

FIGS. 8A and 8B illustrate an example of a communication channel with a server accessed over a communication network.

### DETAILED DESCRIPTION

In the following description, for purposes of explanation, numerous examples and specific details are set forth in order to provide a thorough understanding of embodiments of the present disclosure. Particular embodiments as defined by the claims may include some or all of the features in these examples alone or in combination with other features described below, and may further include modifications and equivalents of the features and concepts described herein.

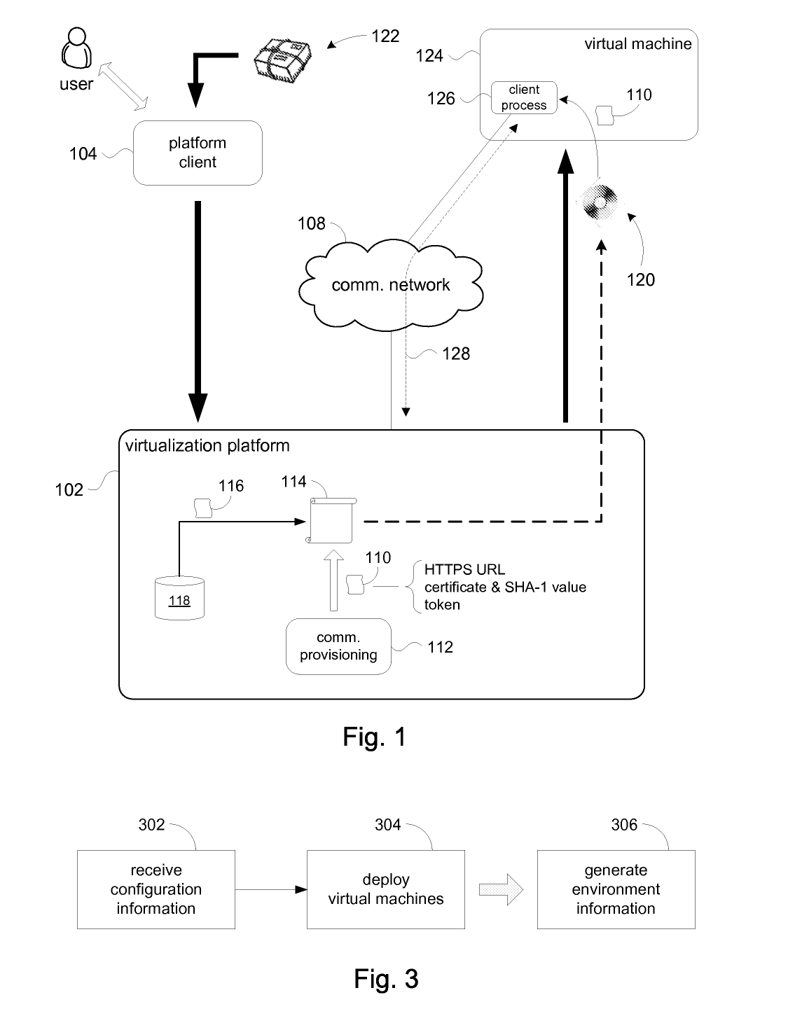

Referring to FIG. 1, a virtualization platform 102 provides a hardware infrastructure and a software infrastructure for administering, managing, and otherwise maintaining configurations of virtual machines. The virtualization platform 102 may include a platform client 104 to provide users (e.g., system administrator, developer) with a suitable interface to access the virtualization platform. The virtualization platform 102 may be connected to a communication network 108, such as a local area network, the Internet, and so on.

A data store 118 may store environment information 116 that is provided to a virtual machine 124 when the virtual machine is started up. The environment information 116 provides information that allows the virtual machine 124 to interact with the virtualization platform 102. In a specific embodiment, for example, the environment information 116 may be OVF environment data specified according to the OVF standard.

In accordance with the present disclosure, the virtualization platform 102 may include a communications provisioning component 112 to deliver communications parameters 110 to the virtual machine 124. The environment information 116 and the communications parameters 110 may be provided on a suitable transport mechanism 114 and 120 for delivery to the virtual machine 124. In a specific embodiment, for example, the transport mechanism may include an ISO image 114 (per the OVF standard) that is generated by the virtualization platform 102, and a virtual CD-ROM 120 to deliver the ISO image 114 to the virtual machine 124. The environment information 116 and the communications parameters 110 may be delivered to the virtual machine 124 in the virtual CD-ROM 120 during a start up process of the virtual machine. For example, the information on the virtual CD-ROM 120 may be read by one or more guests running (executing) on the virtual machine 124. A “guest” generally refers to the operating system (OS) or any process (e.g., applications) executing on the virtual machine 124.

The virtualization platform 102 may deploy one or more virtual machines 124 in accordance with configuration information 122. The configuration information 122 may be provided via a platform client 104. For example, a user (e.g., system administrator) using the platform client 104 may specify the configuration information 122 and cause the configuration information to be downloaded to the virtualization platform 102. The configuration information 122 includes information about each virtual machine to be deployed. In a specific embodiment, for example, the configuration information 122 may be an OVF package per the OVF standard. It will be appreciated, however, that the configuration information 122 may be embodied according to any other suitable virtualization package format. The configuration information 122 may be provided through an application user interface (API), such as for example a VMware vSphere® Web Services API. In accordance with the present disclosure, a client process 126 (e.g., a guest application) running on the virtual machine 124 may establish a two-way communication channel 128 between the virtual machine and the virtualization platform 102 using the communication parameters 110. In some embodiments, the communication channel 128 may be a secure communication channel. Referring to FIG. 1A, for instance, an illustrative example shows that the client process 126 may communicate with a platform process 132 executing on the virtualization platform 102 via a guest API 132a presented by the platform process.

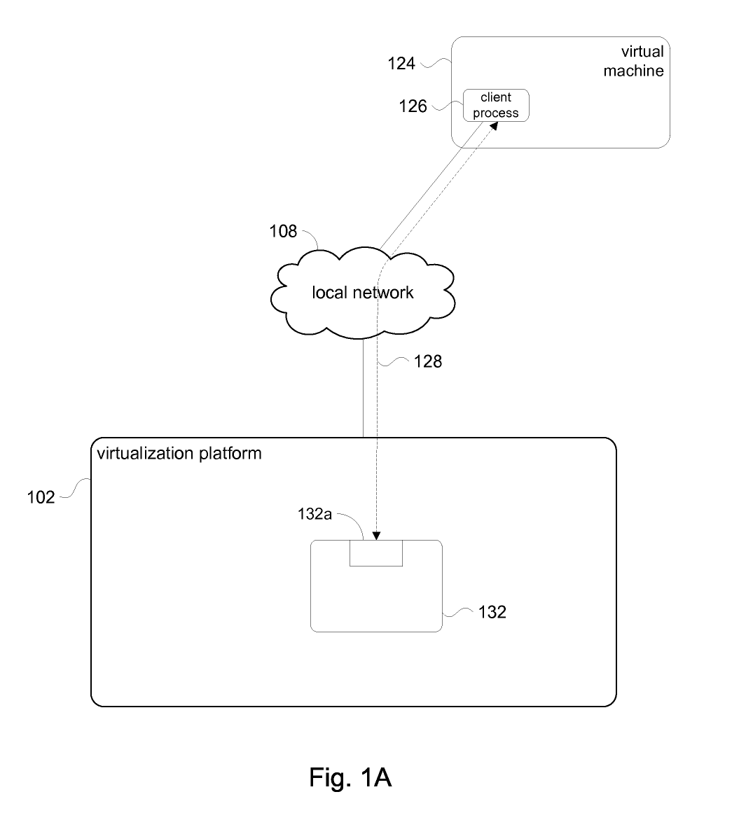

Referring to FIG. 2, a specific embodiment of the virtualization platform 102 will be described merely as an illustrative example. The embodiment shown in FIG. 2 represents the VMware vSphere® virtualization platform 102, produced and sold by the assignee of the present disclosure. The specific embodiment includes a hardware infrastructure 208 comprising a collection of CPUs 222 or other similar computing units, network devices 224, storage devices 226, and the like. A software infrastructure comprises a virtualization layer 206, a management layer 204, and an interface layer 202.

The virtualization layer 206 includes infrastructure services and application services. Infrastructure services such as compute, storage, and network services operate to abstract, aggregate, and allocate hardware or infrastructure resources. Infrastructure services include the following types:
Compute services include the VMware capabilities that abstract away from underlying disparate server resources. Compute services aggregate these resources across many discrete servers and assign them to applications.
Storage services include the set of technologies that enables the most efficient use and management of storage in virtual environments.
Network services include the set of technologies that simplify and enhance networking in virtual environments.
   Application services are services that ensure availability, security, and scalability for applications. Examples include VMware vSphere High Availability and Fault Tolerance.

The management layer 204, called vCenter Server, is the central point for configuring, provisioning, and managing virtualized IT environments. The management layer 204 includes an embodiment of the communications provisioning component 112 of the present disclosure.

The interface layer 202 provides users with access to the virtualization platform 102 through GUI clients 104 such as the vSphere® Client or the vSphere® Web Client. Additionally, users can access the platform through client machines that use command line interfaces and software developer kits (SDKs) to develop automated management tools.

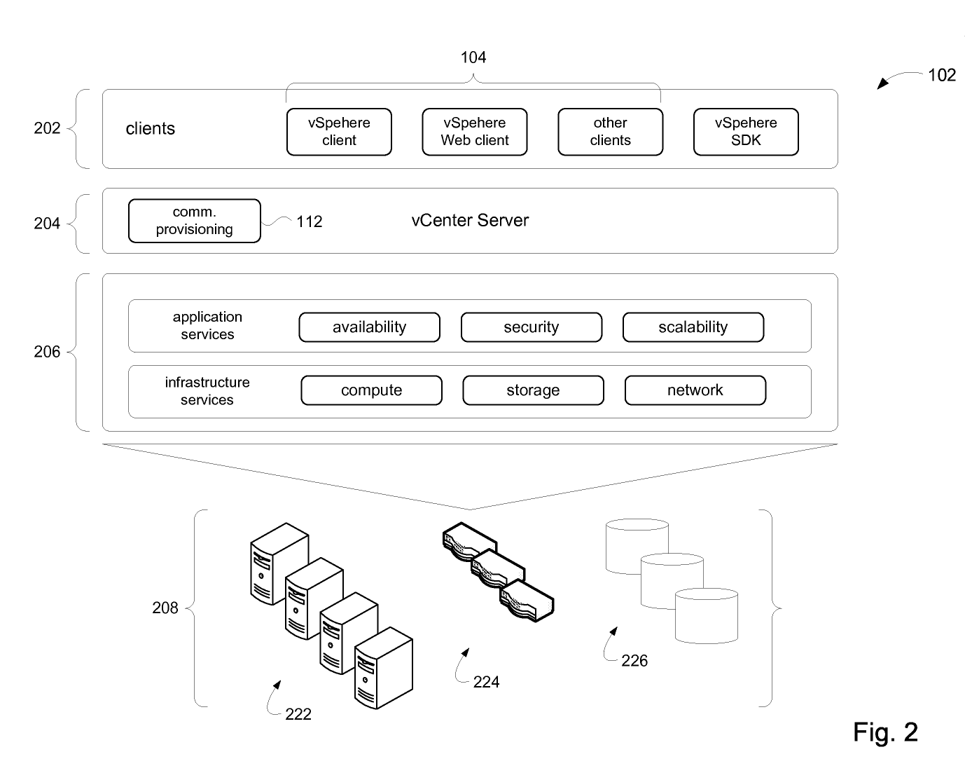

Referring to FIG. 3, a workflow for the deployment of virtual machine(s) 124 on the virtualization platform 102 is shown. In a step 302, the virtualization platform 102 receives configuration information 122; e.g., a file specified by a user working from the platform client 104. In a step 304, the virtualization platform 102 reads the configuration information 122 and defines one or more virtual machines specified in the configuration information. At some time after deployment, in a step 306, the environment information 116 is generated and provided to the virtual machine during a “power on” sequence. The parameters that need to be configured may be specified in the configuration information 122. For example, the configuration information 122 may require that the following information needs to be configured or otherwise provided: domain name server, gateway address of the network that virtual machine will be communicating on, and the like. In embodiments, a user who is performing the deployment may be queried (e.g., via an installation GUI) to supply the specific information. When the environment information 116 is collected, it may be stored in a data store (e.g., data store 118). In a specific embodiment, for example, the workflow shown in FIG. 3 may apply to the OVF standard, where the configuration information 122 is an OVF package and the environment information 116 is an OVF environment.

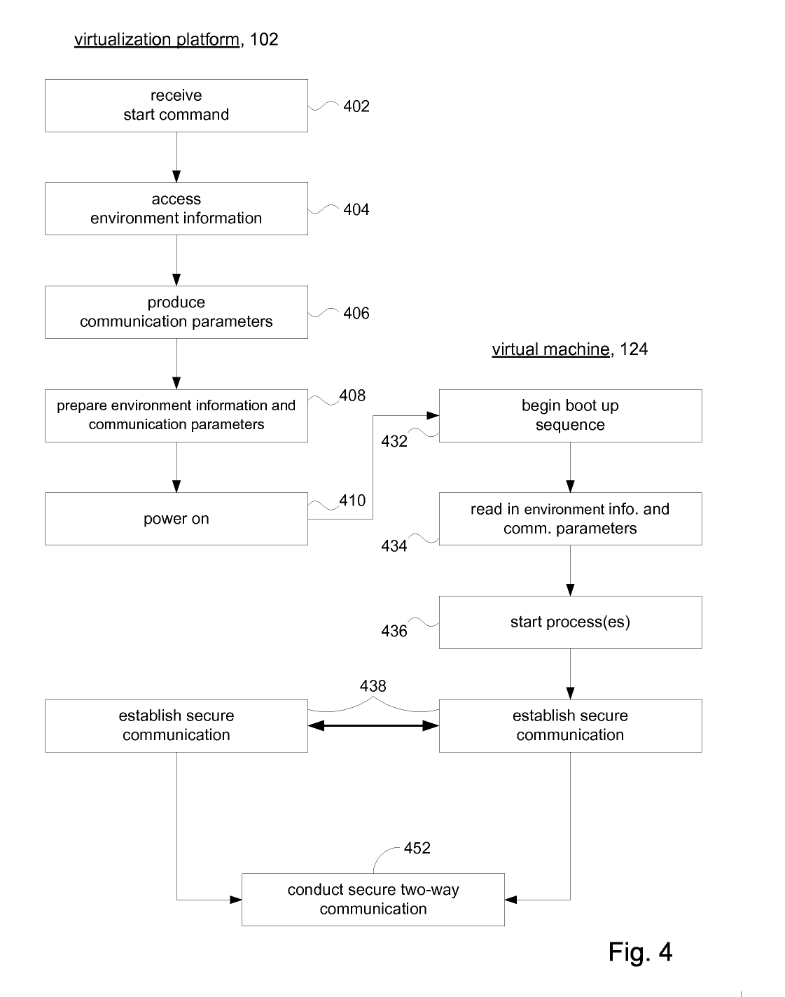

The deployment process defines virtual machines on the virtualization platform 102. After deployment, the virtual machines may be “powered on.” The term “power on” is understood to refer to initiating a start up sequence in a virtual machine; for example, causing the virtual machine to execute a virtual boot ROM. FIG. 4 depicts the general workflow for powering on a virtual machine in accordance with principles of the present disclosure. The workflow includes processing in the virtualization platform 102 and in the virtual machine that is being powered on.

At a step 402 the virtualization platform 102 receives a power on command for a virtual machine 124. In a step 404, the virtualization platform 102 accesses the environment information 116 associated with the virtual machine 124 to be powered on.

In accordance with the present disclosure, the communication provisioning component 112 of the virtualization platform 102 may produce, in a step 406, a set of communication parameters 110. The communication parameters 110 may be selected to ensure secure communications between the virtual machine 124 and the virtualization platform 102. Properties of a secure communication may include:
Privacy: No one but the communicating parties must know what data is sent.
Integrity: It must not be possible for a third party to modify the data sent.
Identity: The platform and guest software must be certain of the other's identity.
Uniqueness: It must not be possible for a third party to retransmit previously observed data.

It will be appreciated that although the virtualization platform 102 instantiates virtual machines 124, embodiments in accordance with the principles of the present disclosure relate to providing a communication channel between guests (e.g., the OS, processes) running on the virtual machine and the virtualization platform. Accordingly, when the discussion refers to a virtual machine communicating with the virtualization platform 102, it may be understood, depending on the particular context, that the virtual machine refers to a guest running on that virtual machine.

A commonly used technology for secured communications over the Internet is hypertext transport protocol secure (HTTPS) connections in a server-client configuration. HTTPS is available in many programming languages and supported by major web browsers and a number of command line tools such as curl and wget. Briefly, a server obtains a verifiable server-side “certificate.” When a client connects to the server using HTTPS, the server sends the certificate to the client. The client verifies the certificate with a certificate authority. A public key contained in the verified certificate can then be used by the client to conduct secure communications with the server. The use of a server-side certificate satisfies the privacy, integrity, and uniqueness properties set forth above.

In some embodiments, therefore, the communication parameters 110 produced in step 406 may be selected for communication based on HTTPS, where the virtualization platform 102 plays the role of a server machine and the virtual machine 124, acting as a client machine, initiates an HTTPS connection to the virtualization platform. It will be appreciated, however, that in other embodiments, variations of the disclosed communication strategy may be used, and more generally a communication strategies based on techniques other than HTTPS may used.

In accordance with principles of the present disclosure, the virtualization platform 102 may be assigned an HTTPS URL (e.g., “https//www.virtual-platform-102.com”) that the virtual machine 124 can connect to. Accordingly, in some embodiments, the communication parameters 110 may include the HTTPS URL so that a guest, acting in the role of client software on the virtual machine 124, may use to connect to the virtualization platform 102. In some embodiments, one HTTPS URL may be defined for the virtualization platform 102 and used for all virtual machine clients deployed on the virtualization platform. In other embodiments, a different HTTPS URL may be defined for each deployed virtual machine client.

In embodiments, the communication parameters 110 may include a SHA-1 hash code value of the server-side certificate. Thus, step 406 may include the virtualization platform 102 applying a SHA-1 hashing algorithm on the server-side certificate to generate a SHA-1 hash code value. As will be explained below, the SHA-1 hash code value may be used by the virtual machine 124 to verify the server-side certificate.

The HTTPS strategy guarantees only the identity of the server vis-à-vis the server-side certificate. This means that only the identity of the virtualization platform (server) 102 can be verified, but not the other way around; the virtualization platform 102 cannot verify the identity of the virtual machine (client) 124. This one-sided verification of identity may be adequate in some embodiments; however, a two-way verification may be more suitable in other embodiments. In other words, it may be desirable that the virtualization platform 102 be able to verify the identity of the virtual machine 124.

Accordingly, the communication parameters 110 may include an authentication token that the virtual machine 124 may use to identify itself to the virtualization platform 102. In some embodiments, for example, step 406 may further include the virtualization platform 102 generating a 128-bit pseudo-random value that serves as the authentication token. The virtualization platform 102 may generate a different authentication token for each virtual machine. It will be appreciated, of course, that the authentication token may be generated using other methods. Processing of the authorization token will be discussed below.

More generally, however, methods other than authentication tokens may be used for verifying the client. For example, an alternative strategy may be the use of a client-side certificate, wherein the virtual machine 124 obtains a verifiable certificate and sends the certificate to the virtualization platform 102. The identity of the virtual machine 124 may then be verified by the virtualization platform 102 in a manner similar to the way the virtual machine had verified the virtualization platform.

Continuing with FIG. 4, in a step 408, the virtualization platform may provide the environment information 116 and the communication parameters 110 on a suitable transport mechanism. For example, the OVF standard specifies storing such “environment” data in an ISO formatted file 114, which may then be provided to the virtual machine 124 as a virtual CD-ROM 120 when the virtual machine is powered on. In a step 410, the virtualization platform 102 initiates a startup process in the virtual machine 124, for example, by powering on the virtual machine.

At a step 432, the virtual machine performs a boot up sequence; for example, the virtual machine may access a fixed location in memory (e.g., a virtual ROM) to begin executing boot up code. The environment information 116 can be read (at a step 434) as part of its startup sequence; e.g., by reading the virtual CD-ROM 120. The virtual machine 124 may then deploy the environment information 116 and the communication parameters 110 when it starts up its OS and processes (e.g., application software) at a step 436. Both the ISO formatted file 114 and the virtual CD-ROM 120 are secure in the sense that only the virtualization platform 102 can write to the former and only a guest on the virtual machine 124 can read the latter.

Processing in the virtual machine 124 then proceeds in accordance with the software that is loaded on the virtual machine. In accordance with the present disclosure, a process (e.g., client process 126 in FIG. 1) running on the virtual machine 124 may set up a secure two-way communication channel 128 between the virtual machine and the virtualization platform 102. For example, in a step 438, the client process 126 and the virtualization platform 102 may establish a secure communication channel using the communication parameters 110. At this point, both ends of the communication (virtualization platform 102 and client process 126) are verified and a secure two-way communication channel (e.g., 128 in FIG. 1) may be deemed to exist between the virtualization platform and the client process. Accordingly, secure two-way communications between the virtualization platform 102 and the client process 126 may be conducted at a step 452 (e.g., using HTTPS).

As an illustrative example, suppose communication parameters 110 are provided to the client process 126 when it is started. The client process 126 may use the HTTPS URL provided in the communication parameters 110 to establish a secure communication channel with the virtualization platform 102 over the communication network 108 (e.g., the Internet). For example, the client process 126 may initiate a connection to the HTTPS URL (step 438). In response, the virtualization platform 102 may respond by communicating to the client process 126 a server-side certificate (e.g., an X.509 certificate) including a public key component of a public-key encryption system.

Conventionally, part of establishing the HTTPS connection involves the server sending its X.509 certificate to the client for verification. This includes sending the client the chain of Certification Authority (CA) certificates that the client can base its trust on. If the client trusts one of the certificates in the chain, typically the root certificate, it trusts the certificate's authenticity. Trust of a CA certificate is often based on the fingerprint of the CA certificate, which is the SHA-1 hash value of the X.509 certificate.

In accordance with the present disclosure, the client process 126 receives information about the server-side certificate directly from the virtualization platform 102 over a trusted channel. This means that the client process 126 can simply verify that the received server-side certificate is the right one by computing its SHA-1 hash code value and comparing the computed value against the SHA-1 hash code value provided in the communication parameters 110. In embodiments, a match between the computed SHA-1 hash code value and the SHA-1 hash code value provided in the communication parameters 110 may be deemed to constitute verification of the received server-side certificate, and hence verification of the server, namely the virtualization platform 102, that sent it.

As mentioned above, the role of the authentication token provided in the communication parameters 110 is to let the virtualization platform 102 verify the identify of the calling process, namely client process 126. Accordingly, the client process 126 may verify itself with the virtualization platform 102 by including the authentication token in the header portion of an HTTP message that is sent to the virtualization platform. Since HTTPS encrypts the entire HTTP message, the authentication token is also encrypted and so will not be sent in plaintext thus preserving the integrity of the authentication token. The virtualization platform 102 may then extract the authentication token from the HTTPS message that is received from client process 126 and use it to verify the identity of the client process.

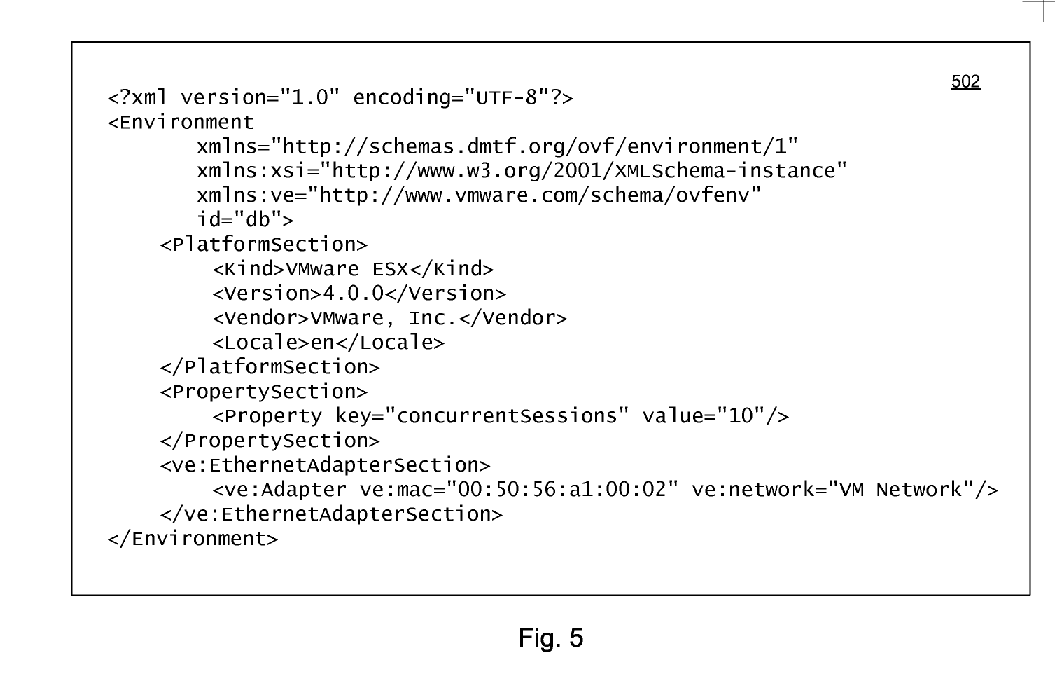

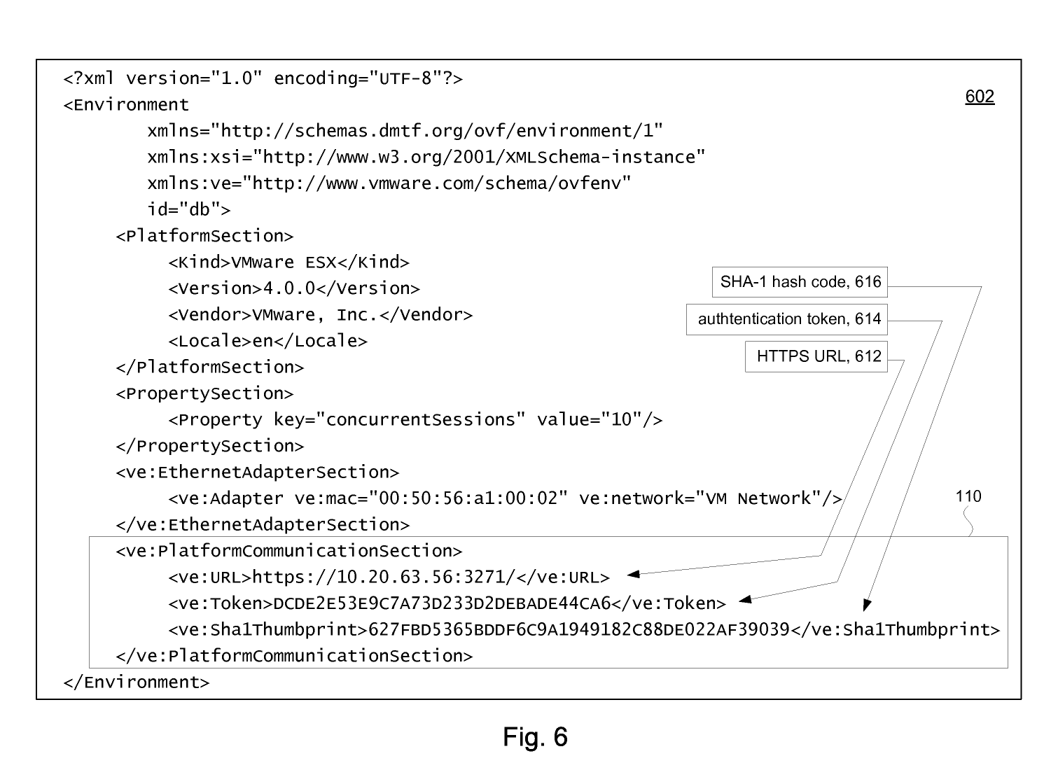

FIG. 5 is an illustrative example of environment information 116 stored in the transport mechanism 114. For example, the transport mechanism 114 may be expressed as an OVF environment document 502 in accordance with the OVF standard. FIG. 6 is an illustrative example of communication parameters 110 comprising, for instance, an HTTPS URL 612, an authentication token 614, and a SHA-1 hash code value 616. In embodiments, the communication parameters 110 may be combined with environment information 116 and stored in the transport mechanism 114. For example, FIG. 6 shows the transport mechanism 114 expressed as an OVF environment document 602.

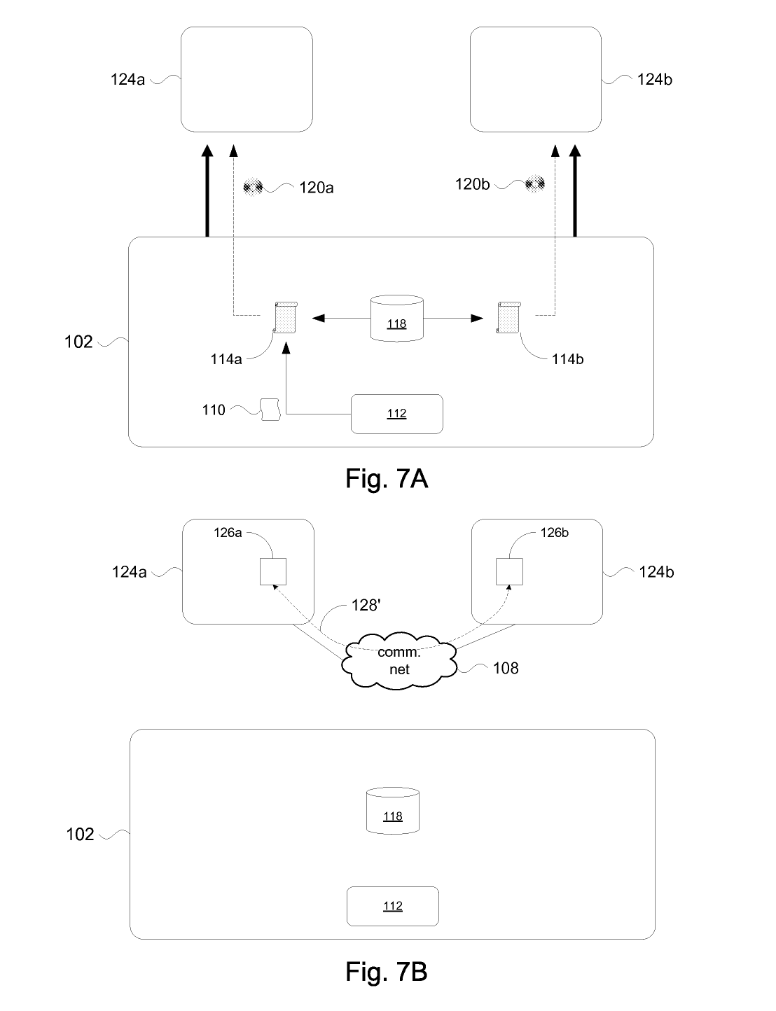

Referring to FIGS. 7A and 7B, in some embodiments, a communication channel may be established between two virtual machines in accordance with the present disclosure. For example, consider a configuration where a virtual machine 124a initiates a communication channel with virtual machine 124b. The communications provisioning component 112 may provide communication parameters 110, as described above, suitable for communication with virtual machine 124b. The communication parameters 110 may be incorporated in ISO image 114a and delivered to virtual machine 124a via virtual CD-ROM 120a after the virtual machine has been started. Virtual machine 124b may be started up, for example, by receiving an ISO image 114b containing environment information delivered as a virtual CD-ROM 120b. After both virtual machines have started up, a process 126a running on virtual machine 124a may initiate a communication channel 128′ (e.g., a secure communication channel) with a process 126b running on virtual machine 124b, in a manner as described above. For instance, the communication parameters 110 provided to one virtual machine (e.g., 124a) may allow that virtual machine to play the role of “server,” and communication parameters 110 provided to the other virtual machine (e.g., 124b) may that virtual machine to play the role of “client.”

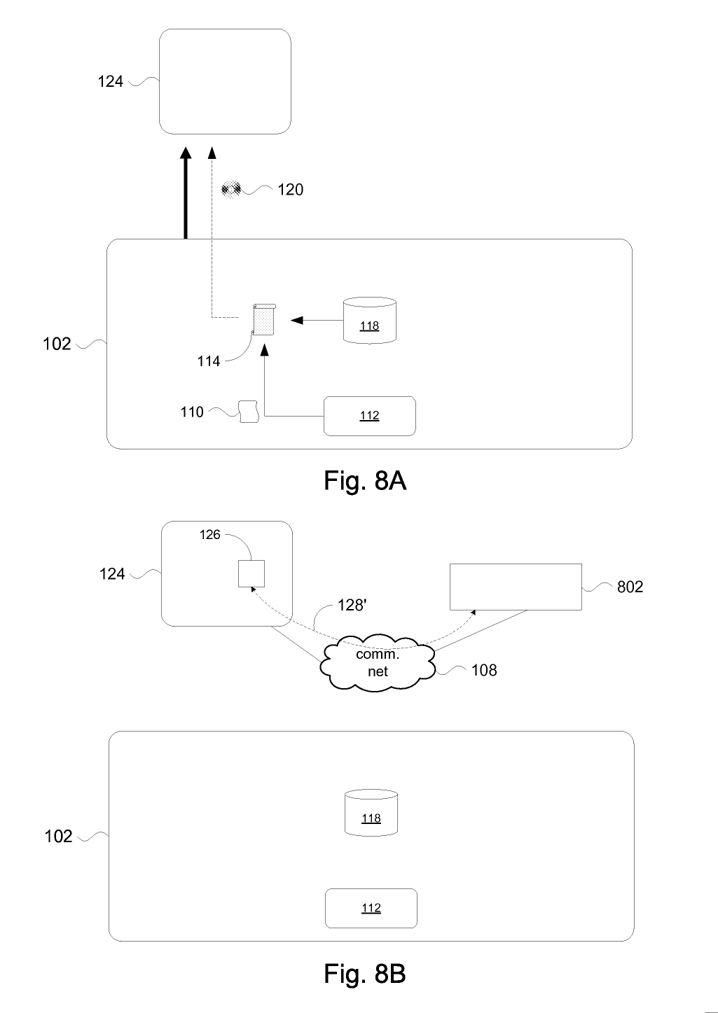

Referring to FIGS. 8A and 8B, in some embodiments, a communication channel may be established between a virtual machine and a server beyond the bounds of the virtualization platform 102 in accordance with the present disclosure. Consider, for example, a configuration where a virtual machine 124 initiates a communication channel with a server 802 accessed over a communication network 108 (e.g., the Internet). The communications provisioning component 112 may provide communication parameters 110 suitable for communication with such a server 802. The communication parameters 110 may be incorporated in ISO image 114 and delivered to virtual machine 124 via virtual CD-ROM 120 after the virtual machine has been started. After the virtual machine 124 has started up, a process 126 running on virtual machine 124 may initiate a communication channel 128′ (e.g., a secure communication channel) with server 802, in a manner as described above. It will be appreciated that other configurations for establishing a communication channel in accordance with the principles set forth in the present disclosure are possible.

One or more embodiments (e.g., communications provisioning component 112) may be implemented as one or more computer programs or as one or more computer program modules embodied in one or more computer readable storage media (e.g., storage 226). The term computer readable storage medium refers to any data storage device that can store data which can thereafter be input to a computer system--computer readable media may be based on any existing or subsequently developed technology for embodying computer programs in a manner that enables them to be read by a computer (e.g., CPUs 222). Examples of a non-transitory computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

In addition, while described virtualization methods have generally assumed that virtual machines present interfaces consistent with a particular hardware system, persons of ordinary skill in the art will recognize that the methods described may be used in conjunction with virtualizations that do not correspond directly to any particular hardware system. Virtualization systems in accordance with the various embodiments, implemented as hosted embodiments, non-hosted embodiments or as embodiments that tend to blur distinctions between the two, are all envisioned. Furthermore, various virtualization operations may be wholly or partially implemented in hardware.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure(s). In general, structures and functionality presented as separate components in exemplary configurations may be implemented as a combined structure or component. Similarly, structures and functionality presented as a single component may be implemented as separate components.

These and other variations, modifications, additions, and improvements may fall within the scope of the appended claims(s). As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents may be employed without departing from the scope of the disclosure as defined by the claims.

1. A method in a virtualization platform of starting up a virtual machine comprising operating a computer system to perform operations including:
accessing environment information relating to the virtual machine;
producing communication parameters which allow a guest running on the virtual machine to communicate with the virtualization platform;
providing the environment information and the communication parameters to the virtual machine during starting up of the virtual machine; and
the virtualization platform receiving a communication from the guest on the virtual machine, the communication being made using at least some of the communication parameters.

2. The method of claim 1 wherein the communication from the guest on the virtual machine is received over a communication network.

3. The method of claim 1 wherein the communication parameters include a Web address.

4. The method of claim 3 wherein the Web address comprises an HTTPS URL.

5. The method of claim 1 wherein the communication parameters include an authentication token that identifies the guest.

6. The method of claim 5 wherein the communication parameters further include a SHA-1 hash code of an X.509 certificate.

7. The method of claim 6 wherein producing the communication parameters includes generating a SHA-1 hash code of an X.509 certificate.

8. The method of claim 1 wherein producing the communication parameters includes generating a token, the method further comprising operating the computer system to perform an operation of verifying authenticity of the communication from the guest on the virtual machine based on whether or not the communication includes the token generated.

9. The method of claim 1 further comprising the virtualization platform sending a communication to the guest on the virtual machine subsequent to receiving the communication from the guest.

10. The method of claim 9 wherein the virtualization platform sends the communication over a communication network.

11. A virtualization platform apparatus comprising:
a computer subsystem; and
a data storage subsystem having stored thereon computer executable program code, the computer executable program code configured to cause the computer subsystem to:
access environment information relating to the virtual machine;
produce communication parameters which allow a guest running on the virtual machine to communicate with the virtualization platform;
provide the environment information and the communication parameters to the virtual machine when starting up the virtual machine; and
receive a communication from the guest on the virtual machine, the communication being made using at least some of the communication parameters.

12. The apparatus of claim 11 further comprising a connection to a communication network, wherein the communication from the guest on the virtual machine is received over the communication network.

13. The apparatus of claim 11 wherein the communication parameters include an HTTPS URL.

14. The apparatus of claim 11 wherein the communication parameters includes a token, wherein the computer executable program code is further configured to cause the computer subsystem to verify authenticity of the communication from the guest on the virtual machine based on whether or not the communication includes the token.

15. The apparatus of claim 11 wherein the computer executable program code is further configured to cause the computer subsystem to send a communication to the guest on the virtual machine subsequent to receiving the communication from the guest.

16. A non-transitory computer readable medium having stored thereon computer executable program code, the computer executable program code configured to cause a computer system of a virtualization platform to:
access environment information relating to deploying a virtual machine on the virtualization platform;
produce communication parameters which allow a guest running on the virtual machine to communicate with a machine other than the virtual machine;
provide the environment information and the communication parameters to the virtual machine when starting up the virtual machine; and
receive a communication from the guest on the virtual machine, the communication being made using at least some of the communication parameters.

17. The non-transitory computer readable medium of claim 16 further comprising computer executable program code configured to cause the computer system to receive the communication from the guest on the virtual machine over a communication network.

18. The non-transitory computer readable medium of claim 16 wherein the machine is the virtualization platform, or another virtual machine, or a server accessible of a communication network.

19. The non-transitory computer readable medium of claim 16 wherein the communication parameters includes a token, wherein the non-transitory computer readable medium further comprises computer executable program code configured to cause the computer system to verify authenticity of the communication from the guest on the virtual machine based on whether or not the communication includes the token.

20. The non-transitory computer readable medium of claim 16 further comprises computer executable program code configured to cause the computer system to send a communication to the guest on the virtual machine subsequent to receiving the communication from the guest.
